(19) United States
(12) Patent Application Publication
(10) Pub. No.: US 2011/0154243 A1
(43) Pub. Date: Jun. 23, 2011

(54) METHOD FOR DISPLAYING A VIRTUAL MODEL OF A MOLDING SYSTEM, AND PART INFORMATION FOR A SELECTED ENTITY MODEL, ON A DISPLAY OF A HUMAN-MACHINE INTERFACE OF A MOLDING SYSTEM COMPUTER

(75) Inventors: François Styga, Fremersdorf (DE); Geoffrey Gow, Palgrave (CA)

(73) Assignee: Husky Injection Molding Systems Ltd., Bolton (CA)

(21) Appl. No.: 13/054,254

(22) PCT Filed: Jul. 14, 2009
(86) PCT No.: PCT/CA2009/000949

§ 371 Date: Jan. 14, 2011

Related U.S. Application Data
(60) Provisional application No. 61/092,136, filed on Aug. 27, 2008.

(51) Int. Cl. G06F 3/048

(52) U.S. Cl. 715/771

(57) ABSTRACT

Embodiments of the present invention teach a human-machine interface of a molding system computer for displaying a virtual model of a molding system and part information for a selected entity model on a display of a human-machine interface of a molding system computer, amongst other things.

### FIELD OF THE INVENTION

The present invention generally relates to, but is not limited to, molding systems, and more specifically the present invention relates to, but is not limited to a human-machine interface of a molding system computer, a method executable in a molding system computer, a method executable in a vendor computer, and a molding system computer associated with a molding system, amongst others.

### BACKGROUND OF THE INVENTION

An operator associated with a molding machine (e.g. molding machine processing technician, maintenance technician, and the like) may periodically require information relating to specific parts of the molding system. For example, the operator may require a part number for a part of the molding system for sake of ordering a corresponding replacement part. As a further example, the operator may require operational information associated with a part of the molding system for sake of configuring the molding system for optimal production. If the operator is fortunate, the part of interest may be visible or reasonably accessible such that a part number marked thereon may be read. However, it is often the case that the part of interest is not readily or conveniently accessible (e.g. to view a part number on a check valve within an injection unit extruder assembly would require significant time and effort to disassemble a barrel assembly thereof), or the size or configuration of the part does not support a part number marked thereon (e.g. a fastener). In such a case, the operator would likely reference a maintenance manual for the molding system, either in printed form or on computer accessible media, and/or contact a service representative associated with the vendor of the molding system for technical assistance. The referencing of the maintenance manual can be a daunting task given the sheer volume of information that has to be included therein for sake of showing and describing the many sub-assemblies and parts that make up the molding system. Another problem associated with maintenance manuals has to do with the fact that they are typically written in a somewhat generic form in order that they may cover a range of system configurations that may or may not be present on the subject molding system. Likewise, contacting the service representative invariably takes time and patience given the challenges associated with relaying technical subject matter over the phone. In many cases the foregoing methods include an uncertainty factor wherein the operator ends up guessing to some extent on the part that needs to be ordered. For example, when ordering job specific hardware, such as, for example, an ejector plate stop for which the length varies in relation to mold ejection stroke, it may be necessary for the operator to select the appropriate part from a table thereof. In other cases, the operator may simply not have enough information to differentiate between several similar looking parts wherein the operator may take the expedient, but expensive, route of ordering more parts than are necessary for the sake of ensuring that the required part is received.

### SUMMARY OF THE INVENTION

In accordance with a first aspect of the present invention, there is provided a human-machine interface of a molding system computer. The human-machine interface comprises a display that is configured to display a virtual model of a molding system, at least in part. The display is further configured to display part information relating to a selected entity model of the virtual model.

In accordance with a second aspect of the present invention, there is provided a method that is executable in a molding system computer having a human-machine interface. The method comprises causing a display of the human-machine interface to display a virtual model of a molding system, at least in part. The method further includes receiving an indication, via the human-machine interface, of a selected entity model of the virtual model and causing the display to display part information relating to the selected entity model.

In accordance with a third aspect of the present invention, there is provided a method that is executable in a vendor computer. The method comprises receiving an indication from a molding system computer, over a communications network, of a requirement to display a virtual model of a molding system, and sending a virtual model display signal to the molding system computer, over the communications network, with which to display the virtual model on a display of a human-machine interface of the molding system computer. The method further includes receiving an indication, over the communications network, of a selected entity model of the virtual model, and sending an entity information signal to the molding system computer, over the communications network, with which to display part information relating to the selected entity model.

In accordance with a fourth aspect of the present invention, there is provided a molding system computer associated with a molding system. The molding system computer comprises a processor, a human-machine interface, and an internal communication network for coupling the processor with the human-machine interface. The processor has access to instructions to perform operations, including causing a display of the human-machine interface to display a virtual model of the molding system, at least in part, and causing the display to display part information for a selected entity model of the virtual model.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 shows a non-limiting embodiment of a human-machine interface that includes, amongst other things, model navigator button and a display, wherein the display is displaying a virtual model of a molding system, a navigator tool for manipulating the display of the virtual model, and a selection pointer;

FIG. 2 shows the human-machine interface of FIG. 1, wherein the display is further displaying part information for an entity model of a gate assembly of the molding system;

FIG. 3 shows the human-machine interface of FIG. 1, wherein the display is displaying the selection pointer in a selection position for toggling an entity suppression icon in the navigator tool for selectively suppressing the display of a gate assembly of the molding system;

FIG. 4 shows the human-machine interface of FIG. 1, wherein the display is displaying the selection pointer in a selection position for selecting a zoom icon of the navigator tool for selectively magnifying a selectable portion within the display of the molding system;

FIG. 5 shows the human-machine interface of FIG. 1, wherein the display is further displaying a selection box outlining a selected portion within the display of the molding system for magnification;

FIG. 6 shows the human-machine interface of FIG. 1, wherein the display is further displaying a magnified view of the selected portion of the molding system along with part information for an entity model of a bell housing of a clamp block assembly of the molding system;

FIG. 7 shows the human-machine interface of FIG. 1, wherein the display is displaying the entity model selection pointer in a selection position for selecting a translucency icon of the navigator tool for selectively adjusting the translucency of the entity model of the bell housing;

FIG. 8 shows the human-machine interface of FIG. 1, wherein the display is displaying the entity model of the bell housing in a semi-transparent form thereby revealing an entity model of a center cylinder piston of a stroke piston assembly, shrouded therein, and wherein the display is further displaying part information for the center cylinder piston;

FIG. 9 shows the human-machine interface of FIG. 1, wherein the display is displaying the entity model selection pointer in a selection position for selecting an information icon of the navigator tool for selectively displaying auxiliary part information relating to the center cylinder piston;

FIG. 10 shows the human-machine interface of FIG. 1, wherein the display is displaying a part information tool having the auxiliary part information relating to the center cylinder piston;

FIG. 11 shows the human-machine interface of FIG. 1, wherein the display is displaying a search tool having information for searching for a virtual model of a stack assembly of the molding system;

FIG. 12 shows the human-machine interface of FIG. 1, wherein the display is displaying the search tool having search results for the stack assembly;

FIG. 13 shows the human-machine interface of FIG. 1, wherein the display is displaying the virtual model of the stack assembly;

FIG. 14 shows a non-limiting embodiment of a system for implementing various methods for, amongst other things, displaying a virtual model of a molding system and part information for a selected entity model therein;

FIG. 15 shows another non-limiting embodiment of the system for implementing the various methods;

FIG. 16 shows a flow chart of a method, the method executable within a molding system computer of the system of FIG. 14 or 15; and

FIG. 17 shows a flow chart of a method, the method executable within a vendor computer of the system of FIG. 14 or 15.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF EMBODIMENTS

### Introduction

To assist the operator in efficiently and more definitively retrieving the required part information relating to a part of interest of a molding system, various structures and steps will be described hereafter that provide for displaying a virtual model of the molding system and the part information relating to a selected entity model of the virtual model on a display of a human-machine interface that is associated with a molding system computer of the molding system.

### Molding System:

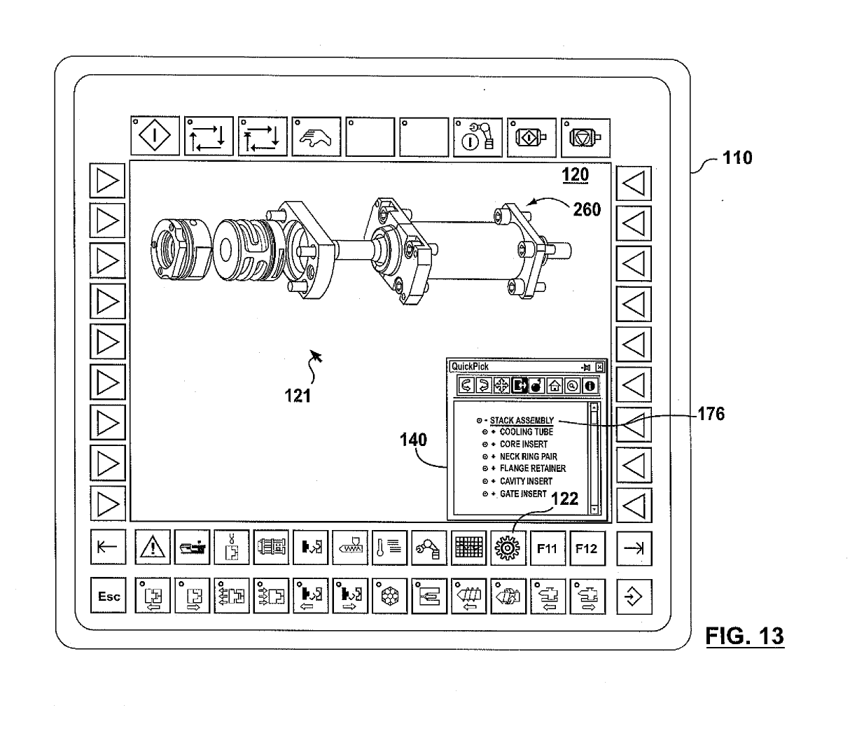

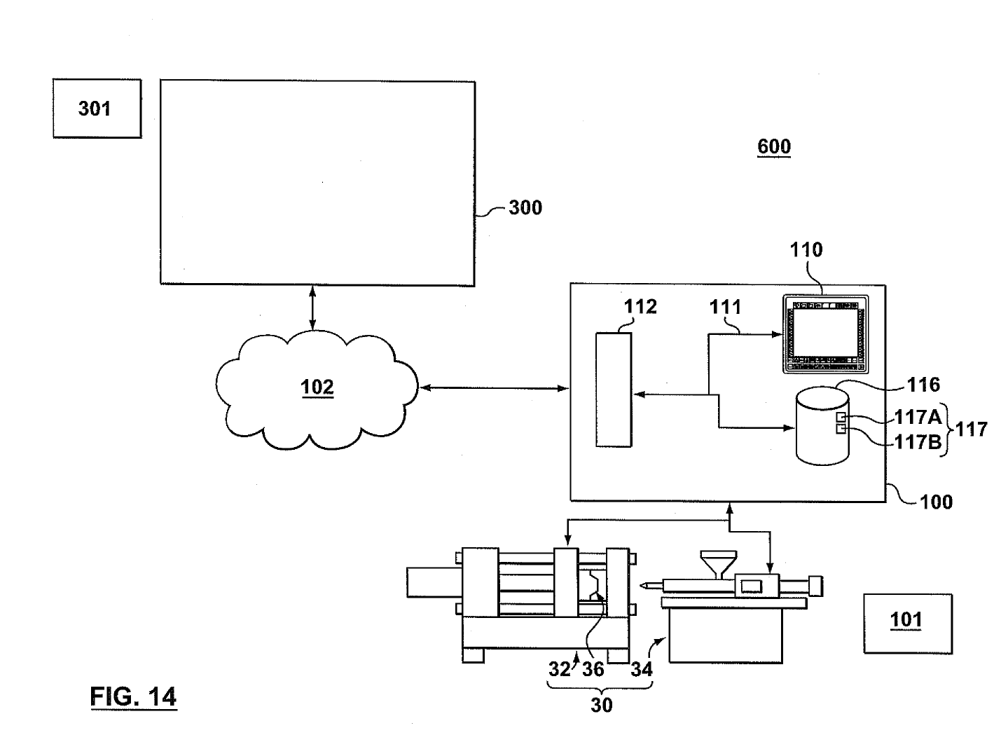

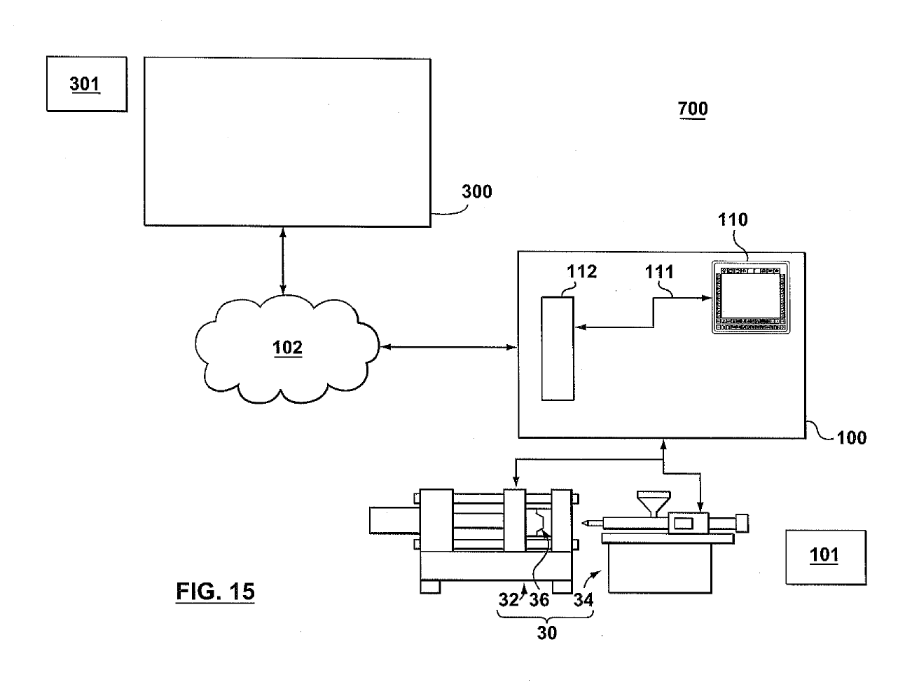

In the description that follows, the non-limiting embodiment of a molding system 30, as shown in FIGS. 14 and 15, includes a molding clamp 32 for operating a mold 36, and an injection unit 34 for supplying molding material to the mold 36. The construction and operation of the foregoing portions of the molding system 30 are well known to those of skill in the art and hence will not be described in detail herein. However, where the term ‘molding system’ is used in the claims that follow, the term is intended to be construed broadly so as to encompass not only the scope of the non-limiting embodiment of the molding system 30 as described above, but alternatively any portion thereof, such as, for example, one or more of a melt distribution devices (i.e. a hot runner—not shown), the mold 36, a stack assembly (FIG. 13) of the mold 36, the molding clamp 32, the injection unit 34, a post-mold device (e.g. end-of-arm tool—not shown), an auxiliary device (e.g. chiller, dehumidifier, dryer, etc.—not shown), and the like.

### Molding System Computer:

In the description that follows, reference will be made to a molding system computer 100, non-limiting embodiments of which are shown in FIGS. 14 and 15, which is associated with the molding system 30 for controlling the operation thereof. The molding system computer 100 may be implemented, at least in part, with a general purpose computer such as, for example, a model ‘C6925’ industrial PC from Beckhoff Automation GmbH of Verl Germany (www.beckhoffautomation.com). The underlying structure and operation of the molding system computer 100 will not be described in detail herein as it is generally consistent with the state of the art and more particularly in keeping with the teachings of co-owned U.S. Pat. No. 6,275,741 to Christopher Choi published on Aug. 14, 2001. At a high level, the molding system computer 100 includes a processor 112, a human-machine interface 110, and an internal network 111 for coupling the processor 112 with the human-machine interface 110. The molding system computer 100 may further include (e.g. coupled to the processor 112 via the internal network 111), or otherwise have access to (e.g. via a communications network 102), a database 116 embodying product data 117, a description of which is to follow.

### Vendor Computer:

In the description that follows, reference will also be made to a vendor computer 300, non-limiting embodiments of which are shown in FIGS. 14 and 15. The vendor computer 300 is associated with a vendor 301 of the molding system 30. The vendor computer 300 may be implemented, at least in part, with a general purpose computer such as, for example, a model ‘PowerEdge 2900 III’ server from Dell Computer Corporation of Austin Tex., U.S.A. (www.dell.com). The underlying structure and operation of the vendor computer 300 will not be described in detail herein as it is generally consistent with the state of the art

### Human-Machine Interface:

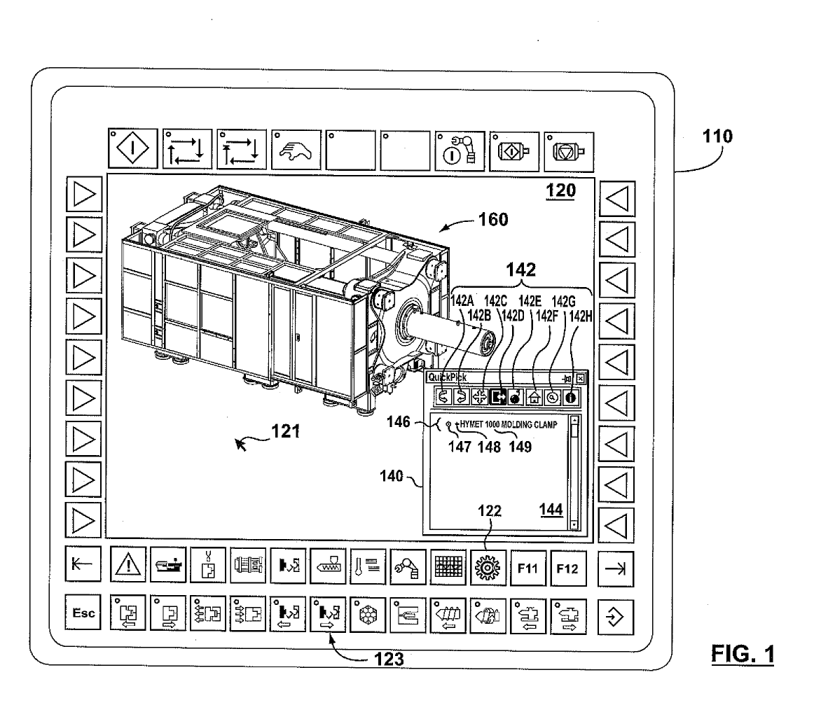

With reference to FIG. 1, there is shown a non-limiting embodiment of the human-machine interface 110. The human-machine interface 110 includes various input and output devices that are used, in operation, by an operator 101 (FIGS. 14 and 15) for managing and reporting on, respectively, various operational control parameters and operational status information, amongst other things, of the molding system 30. One such output device is a display 120 for displaying the reporting information and/or control parameters thereon. The display 120 may be of any type, including, for example, a liquid crystal display. The display 120 is also configured as a display input device wherein a touch sensitive surface is provided thereon, whereby the operator 101 may navigate a selection pointer 121 around the display 120 for selectively manipulating the information and/or operational control parameters displayed thereon. Additional input devices are provided by a plurality of function buttons 123 that surround the display. Each function button of the plurality of function buttons 123 are associated with one or more routine of instructions that are executable by the processor 112 of the molding system computer 100 for controlling an operational aspect of the molding system 30, amongst other things. The human-machine interface 110 shown in FIG. 1 is merely an example, and those skilled in the art will readily appreciate that the structure thereof can be varied. The underlying construction and operation of the human-machine interface 110 will not be described in detail herein as it is generally consistent with the state of the art and more particularly in keeping with the teachings of co-owned U.S. Pat. No. 6,684,264 to Christopher Choi published on Jan. 27, 2004.

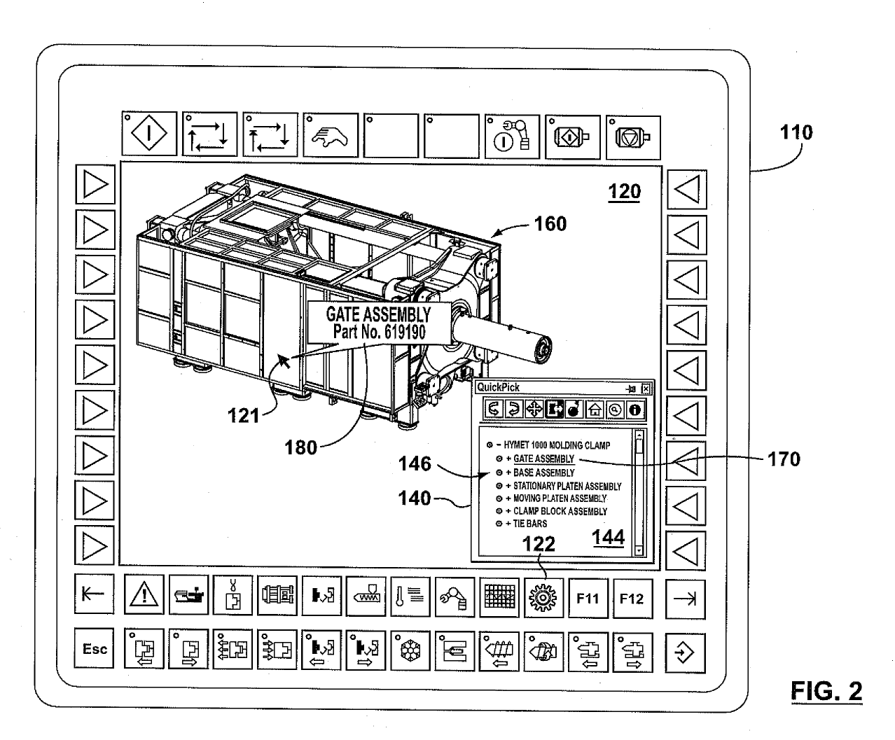

The human-machine interface 110 implementable in accordance with the non-limiting embodiment goes beyond the current state of the art in that it has been configured to display 120 a virtual model 160 of the molding system 30 (FIGS. 14 and 15), at least in part, and part information 180 (FIG. 2) relating to a selected entity model 170 of the virtual model 160. The selected entity model 170 being selectable by the operator 101 (FIGS. 14 and 15) of the molding system 30 (FIGS. 14 and 15) within the display of the virtual model with the assistance of the selection pointer that is associated with the display input device (not shown) of the human-machine interface 110. A technical effect of the foregoing is that the operator 101 is provided with a tool whereby the virtual model of the molding system 30 may be quickly and easily interrogated to determine requisite part information in relation to an entity model that is associated with a part of the molding system 30 of current interest.

The human-machine interface 110 is configured wherein one of the plurality of function buttons 123 includes a model navigator button 122 that is selectable, in operation, by the operator 101 (FIGS. 14 and 15) for launching the display of the virtual model 160 and a navigator tool 140 on the display 120. In addition, a navigator tool 140 is displayed alongside the virtual model 160 on the display 120. The navigator tool 140 is accessible to the operator via the selection pointer 121 for conveying instructions on how the display of the virtual model 160 is to be manipulated to reveal the entity model that corresponds with the part of the molding system 30 of interest, amongst other things.

The non-limiting embodiment of the navigator tool 140 that is displayed on the display 120 in FIG. 1 includes a navigator icon displayed in a navigator toolbar 142, the navigator icon being associated with instructions for manipulating the display of the virtual model 160. More particularly, the navigator toolbar 142 includes a rotation icon 142A, a counter-rotation icon 142B, a pan icon 142C, a translucency icon 142D, an explosion icon 142E, a home icon 142F, a zoom icon 142G, and an information icon 142H. The rotation icon 142A is associated with instructions that are executable by the processor 112 for selectively rotating the display of the virtual model 160. The counter-rotation icon 142B is associated with instructions that are executable by the processor 112 for selectively counter-rotating the display of the virtual model 160. The pan icon 142C is associated with instructions that are executable by the processor 112 for selectively panning the display of the virtual model 160. The translucency icon 142D is associated with instructions that are executable by the processor 112 for selectively adjusting the translucency of the selected entity model 172 (FIG. 2) within the display of the virtual model 160. The explosion icon 142E is associated with instructions that are executable by the processor 112 for selectively manipulating a spatial representation of a plurality of entity models within the display of the virtual model 160. The home icon 142F is associated with instructions that are executable by the processor 112 for selectively returning the display of the virtual model 160 to an initial view thereof. The zoom icon 142G is associated with instructions that are executable by the processor 112 for selectively magnifying a selectable portion within the display of the virtual model 160. The information icon 142H is associated with instructions that are executable by the processor 112 for displaying a part information tool 190 for selectively displaying auxiliary part information 192 relating to the selected entity model 174.

The non-limiting embodiment of the navigator tool 140 that is displayed on the display 120 in FIG. 1 also includes a pane 144 within which to display an entity model listing 146 of entity models that are associated with the selected entity model 170 (FIG. 2). In addition, each entity model displayed in the entity model listing 146 is displayed along with an entity suppression icon 147 and a list expansion icon 148. The entity suppression icon 147 is associated with instructions that are executable by the processor 112 for selectively suppressing the display of the entity model. The list expansion icon 148 is associated with instructions that are executable by the processor 112 for selectively expanding a sub-listing of associated entity models.

As presently configured, a selection of the model navigator button 122 by the operator 101 defaults to the display of the virtual model 160 on the display 120 in accordance with a predefined view of a molding clamp 32 (FIGS. 14 and 15) of the molding system 30 (FIGS. 14 and 15). As shown in FIG. 1, the virtual model 160 of the molding clamp 32 is displayed on the entity model listing 146 as a ‘HYMET 1000 MOLDING CLAMP’, which is commercial product of Husky Injection Molding Systems Limited of Bolton, ON, Canada (www.husky.ca).

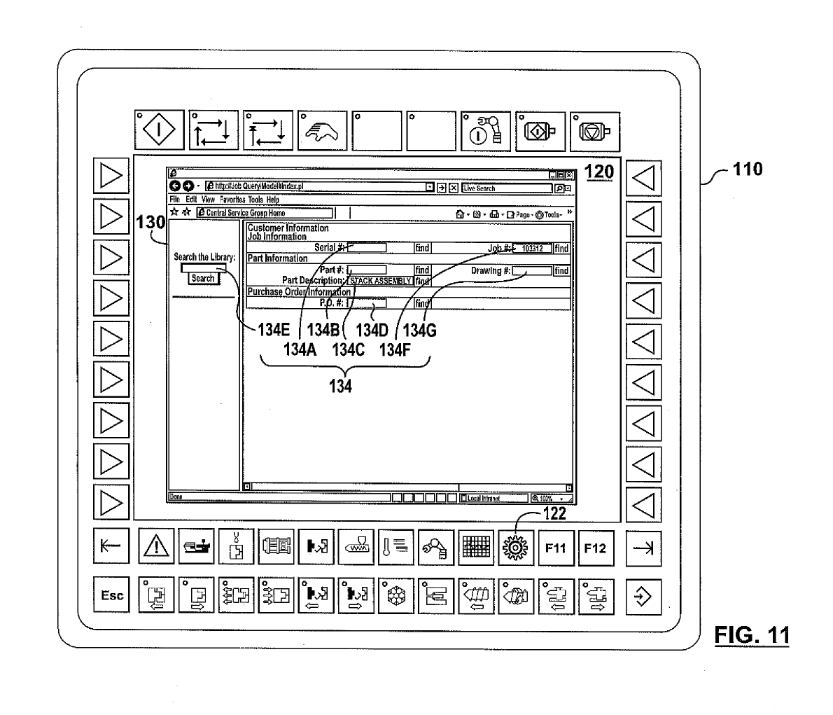

Alternatively, and as shown in FIG. 11, the selection of the model navigator button 122 by the operator 101 could otherwise default to the display of a search tool 130, on the display 120 of the human-machine interface 110, with which to search for the virtual model 260 (FIG. 13) of any desired virtual model that is associated with the molding system 30 (FIGS. 14 and 15). The non-limiting embodiment of the search tool 130 that is displayed on the display 120 includes a searchable field 134 by which the operator 101 (FIGS. 14 and 15) may search for a desired virtual model 260 (FIG. 13). The searchable field 134 includes a serial number field 134A, a part number field 134B, a part description field 134C, a purchase order field 134D, a free-form field 134E, a job number field 134F, and a drawing number field 134G. In the example given in FIG. 11, the operator 101 has already populated search criteria, via the display input device (not shown), into the part description field 134C and the job number field 134F relating to a request to display the virtual model 260 corresponding to a stack assembly of a mold 36 (FIGS. 14 and 15). In response to the search for the virtual model 260 of the stack assembly, the search tool 130 displays a selectable link 136 to the virtual model 260, a selection of which by the operator 101 initiates the display of the virtual model 260 thereof as shown in FIG. 13.

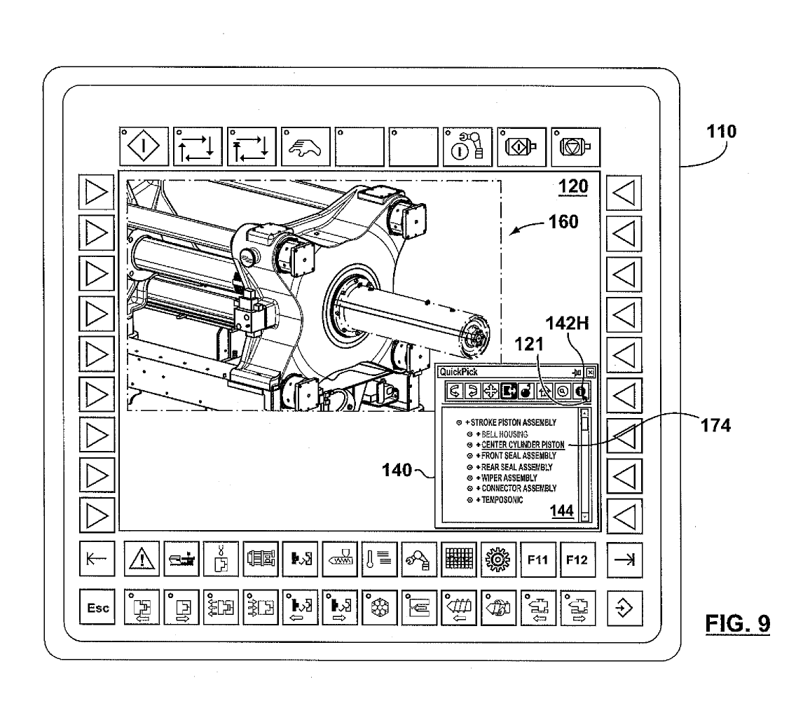

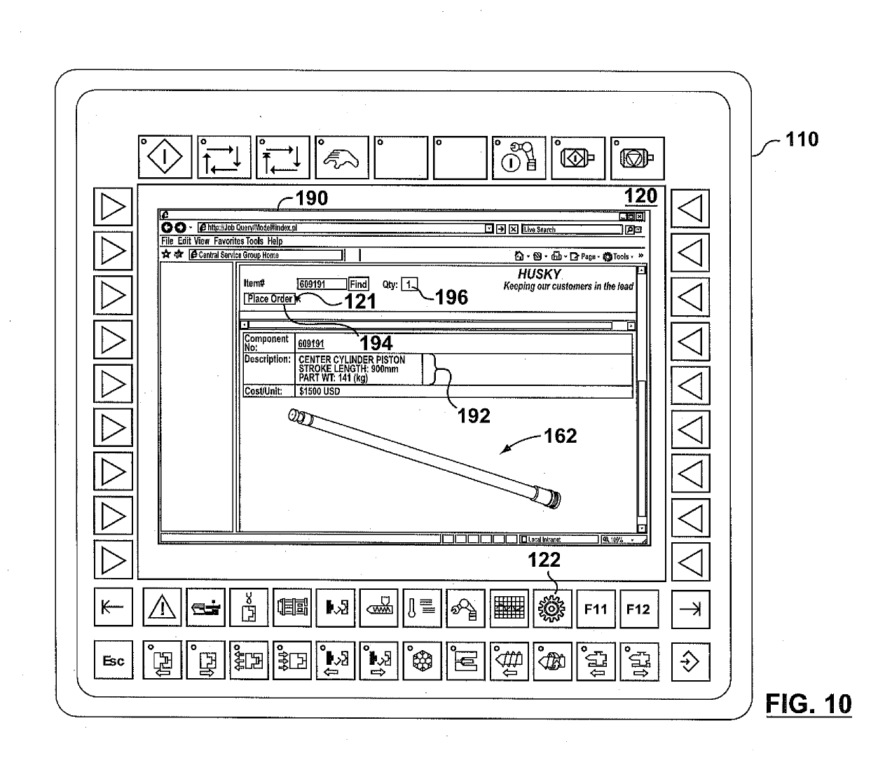

Under certain circumstances the operator 101 (FIG. 14 or 15) may require auxiliary part information 192 (FIG. 10) in relation to the part of the molding system 30 (FIG. 14 or 15) that corresponds to the selected entity model 170 that is not initially displayed with the part information 180 (FIG. 2) on the display 120. That is, the part information 180 is, by default, cursory in nature and includes only a part number and part description (e.g. reference the example of the ‘GATE ASSEMBLY Part No. 619190’ that is displayed in FIG. 2). The auxiliary part information 192 associated with a part may include, for example, various physical or operational parameters associated with the part, amongst others. To access the auxiliary part information 192, the operator 101 would select the information icon 142H on the navigator tool 140 with the selection pointer 121 whereupon a part information tool 190 (FIG. 10) would be displayed on the display 120. The display of the part information tool 190 includes the auxiliary part information 192, amongst other things. In the example shown in FIG. 10, the part information tool displays not only the auxiliary part information 192, but also a virtual model 162 that is associated with the selected entity model 174 (FIG. 9). As shown, the auxiliary part information 192 includes not only the part description (i.e. ‘CENTER CYLINDER PISTON’) but also an operational parameter (i.e. ‘STROKE LENGTH: 900 mm) and a physical parameter (i.e. ‘PART WT: 141 (kg)’).

The part information tool 190 is also configured to display an ordering link 194 and a quantity field 196 with which the operator 101 (FIG. 14 or 15) may interact, with the assistance of the display input device (not shown) of the human-machine interface 110, to provide an indication to a vendor computer 300, over the communications network 102 (FIG. 14 or 15), of a request to purchase a quantity of the part of the molding system 30 that corresponds with the selected entity model 174 from a vendor 301 of the molding system 30 that is associated with the vendor computer 300. Likewise, the part information tool 190 may be configured to display an auxiliary link (not shown) for providing an indication to the vendor computer 300, over the communications network 102, of a request for an auxiliary operation (e.g. molding system maintenance) to be performed in association with the part.

### Visualization Routine:

The processor 112 embodies or has access to instructions of visualization routine to perform operations for generating the display of the virtual model 160 and the part information for the selected entity model on the display 120. The visualization routine also includes instructions that are executable by the processor 112 for generating the display of a navigator tool 140 and performing the various functions associated therewith. The visualization routine may be provided by any computer aided design (CAD) tool. For example, the CAD tool may be implemented using the ‘NX’ CAD tool from Siemens PLM Software Incorporated of Munich, Germany. However, in the non-limiting embodiment herein, the visualization routine is more practically implemented using a product lifecycle management (PLM) software program such as ‘TEAMCENTER VISUALIZATION’ (Tc Vis) from Siemens PLM Software Incorporated. Typical PLM software, such as Tc Vis, are configured to use entity models that are stored in a ‘lightweight’ file format whereby the file size is only a small fraction (i.e. about 12%) in comparison to the original CAD file. In the non-limiting embodiment herein, the file format chosen for the entity models corresponding to the parts of the molding system 30 (FIGS. 14 and 15) is the so-called ‘JT’ format which is a 3D data format developed by Siemens PLM Software Incorporated. This file format contains, amongst other things, approximate (faceted) data, part information, and Metadata (textual attributes) as exported from a native CAD system that is associated with the vendor 301 (FIG. 14 or 15). In addition, the non-limiting embodiment of the ‘JT’ files are further configured to provide only an approximate representation of the associated CAD file whereby the underlying proprietary design definition information is not exposed. For the avoidance of doubt, other file formats, whether large or small in size, could otherwise be used.

### System

With reference to FIG. 14, there is shown a non-limiting embodiment of a system 600 that includes the molding system computer 100 and the vendor computer 300 that are linked via the communications network 102 (e.g. Internet, wide area network, virtual private network, etc.). The molding system computer 100 includes, or has access to, a database 116 containing the ‘JT’ files of the entity models that are associated with the parts of the molding system 30. More particularly, the database 116 embodies product data 117 (e.g. the ‘JT’ files) for each part of the molding system 30. The product data 117 includes model data 117A with which to display the various entity models that are associated with the virtual model 160. In addition, the product data 117 includes part data 117B with which to display the part information and the auxiliary part information for the selected entity model 170. In this non-limiting embodiment, the vendor 301 of the molding system 30 would have pre-configured product data 117 from the native CAD system that is associated with the vendor 301 and have stored it within the database 116 prior to delivery of the molding system 30 to the operator 101. Of course, other means of delivering and maintaining the product data 117 are possible, as will be apparent to those of skill in the art. For example, the vendor 301 could otherwise send or update the product data 117 by means of computer readable memory (e.g. CD-ROM, FLASH storage device, etc.) or over the communications network 102 from the vendor computer 300. In some cases the computer readable memory may be associated (e.g. linked or otherwise accompanying) with one or more of the parts (e.g. mold 36) of the molding system 30 and be made accessible to the molding system computer 100 by wired or wireless means. In this non-limiting embodiment of the system 600, the vendor computer 300 is also configured to function as, or have access to, an enterprise resource planning (ERP) system with which to manage the fulfillment of the request, of the operator 101, to purchase the quantity of the part of the molding system 30 that corresponds with the selected entity model 174, and/or likewise, manage the request for an auxiliary operation to be performed in association with the part. The structure and operation of the ERP system is well known to those of skill in the art and hence will not be described in any detail herein beyond the basics that it is a business support system that maintains in a single database the data needed for a variety of business functions such as Manufacturing, Supply Chain Management, Financials, Projects, Human Resources and Customer Relationship Management, amongst others.

With reference to FIG. 15, there is shown another non-limiting embodiment of a system 700 that includes the molding system computer 100 and the vendor computer 300 that are linked via the communications network 102. What differentiates the system 700 from the system 600 (FIG. 14) described previously is location of the database 116 (FIG. 14) containing the product data 117 (FIG. 14). Instead of associating the database 116 (FIG. 14) locally with the molding system computer 100, it is instead associated remotely with the vendor computer 300. Accordingly, in operation, the product data (not shown) is made accessible to the processor 112 of the molding system computer 100 (FIG. 15), via the communications network 102, whereafter it is displayed on the display 120 with the assistance of the visualization routine that is executable by the processor 112 (FIG. 15).

Alternatively, the system 700 may be further configured wherein a processor (not shown) thereof has access to the visualization routine for generating the virtual model display signal for transmission to the molding system computer 100 for display on the display 120. A technical effect of such a server-based implementation may include the alleviation of logistics associated with updating of the virtual model 160 of the molding system 30 that may be necessitated with a change to the configuration of the molding system 30 (e.g. a retrofit or upgrade).

### Method Executable in the Molding System Computer:

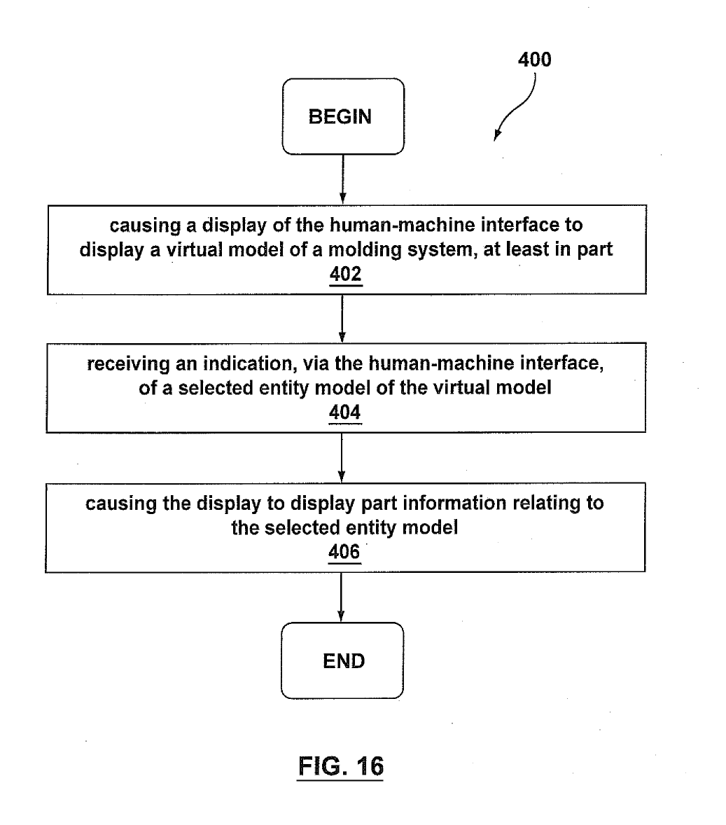

With reference to FIG. 16, there is shown a method 400 executable in the non-limiting embodiment of the molding system computer 100 of the system 600 (FIG. 14). As discussed previously, within the system 600 the molding system computer 100 includes, or has access to, the database 116 (FIG. 14) embodying the product data 117 (FIG. 14), and wherein the molding system computer 100 is generally responsible (i.e. locally implemented) for the execution of executable instructions that are associated with the display and manipulation of the virtual model.

### Step 402:

Method 400 begins at step 402, with a causing of the display 120 of the human-machine interface 110 to display the virtual model 160 of the molding system 30, at least in part. More particularly, the processor 112 of the molding system computer 100, having access to the instructions of the visualization routine, performs the operations of reading the model data 117A, generating a virtual model display signal with which to display the virtual model 160 (FIG. 1) on the display 120 (FIG. 1), and sending the virtual model display signal to the display 120 (FIG. 1) over the internal network 111.

Next, the processor 112 of the molding system computer 100 proceeds to execution of step 404.

### Step 404:

Method 400 continues at step 404, with the receiving of an indication, via the human-machine interface 110, of the selected entity model 170 of the virtual model 160. More particularly, the processor 112 of the molding system computer 100, receives the indication from the operator 101, via the operation of the selection pointer 121 of the display input device (not shown) of the human-machine interface 110, of the selected entity model 170 of the virtual model 160 (FIG. 1).

Next, the processor 112 of the molding system computer 100 proceeds to execution of step 406.

### Step 406:

Method 400 typically ends at step 406, with causing the display 120 to display part information 180 relating to the selected entity model 170. More particularly, the processor 112 of the molding system computer 100, having access to the instructions of the visualization routine, performs the operations of reading the part data 117B, generating the virtual model display signal to display the virtual model 160 (FIG. 1) along with the part information 180 that is associated with the selected entity model 170, and sending the virtual model display signal to the display 120 (FIG. 1) over the internal network 111.

The method 400 may further include the additional steps of receiving an indication, via the operation of the navigator tool 140 (FIG. 1) with the display input device (not shown), of a requirement to manipulate the display of the virtual model 160 (FIG. 1), and causing the display 120 (FIG. 1) of the human-machine interface 110 to manipulate the display of the virtual model 160 of the molding system 30 in accordance with the indication.

The method 400 may further include the additional steps of receiving an indication, via the operation of the ordering link 194 (FIG. 10) of the part information tool 190 (FIG. 10) with the display input device (not shown), of a demand for a part of the molding system 30 that corresponds with the selected entity model 174 (FIG. 9), and causing the molding system computer 100 to send an order signal to a vendor computer 300, over the communications network 102, requesting that the vendor 301 provide the part of the molding system 30.

Likewise, the method 400 may further include the additional steps of receiving an indication, via the operation of the auxiliary link of the part information tool 190 (FIG. 10) with the display input device (not shown) of a demand for an auxiliary operation to be performed on a part of the molding system 30 that corresponds with the selected entity model 174 (FIG. 9), and causing the molding system computer 100 to send an auxiliary signal to the vendor computer 300, over the communications network 102, for requesting the vendor 301 to perform the auxiliary operation on the part of the molding system 30.

The method 400 may further include the additional steps of receiving an indication, via the operation of the information icon 142H (FIG. 1) of the navigator tool 140 (FIG. 1) with the display input device (not shown), of a requirement to display auxiliary part information 192 (FIG. 10) relating to the selected entity model 174 (FIG. 9), and causing the display 120 (FIG. 1) to display the auxiliary part information 192.

Prior to the step 402 of causing the display 120 (FIG. 1) of the human-machine interface 110 to display the virtual model 160 (FIG. 1) of the molding system 30, the method 400 may further include the steps of sending an indication to the vendor computer 300, over the communications network 102, of a requirement for the virtual model display signal from the vendor computer 300 with which to display the virtual model 160, and receiving the virtual model display signal from the vendor computer 300, over the communications network 102.

Likewise, the method 400 may further include the steps of sending an indication to the vendor computer 300, over the communications network 102, of a requirement for a part information display signal for the selected entity model 170 (FIG. 2) of the virtual model 160 (FIG. 1), and receiving the part information display signal from the vendor computer 300, over the communications network 102, with which to display the part information 180, 182, 184 relating to the selected entity model 170 on the display 120.

### Method Executable in the Vendor Computer:

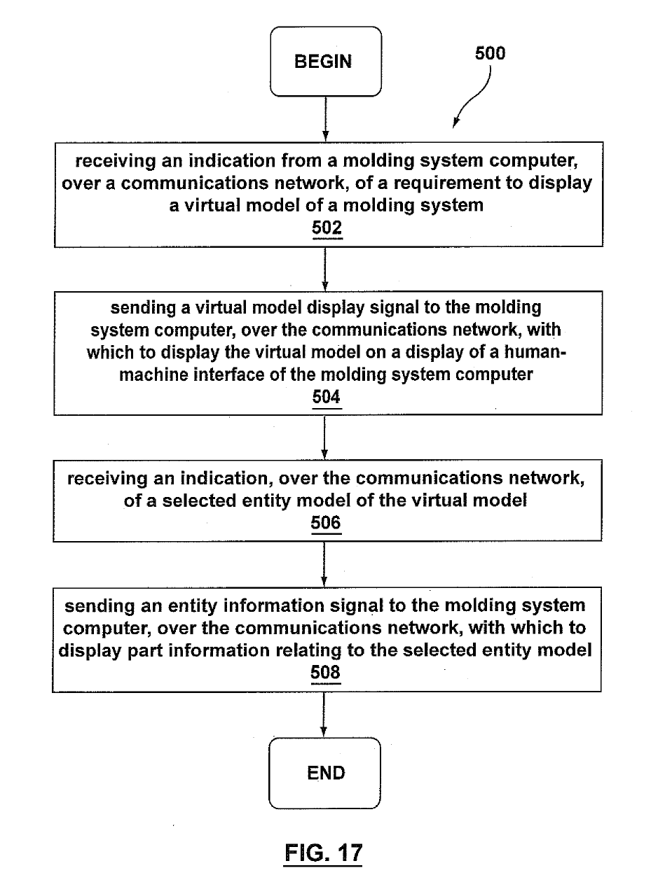

With reference to FIG. 17, there is shown a method 500 that is executable in the non-limiting embodiment of the vendor computer 300 of the system 700 (FIG. 15). As discussed previously, within the system 700 the vendor computer 300 includes, or has access to, the database (not shown) embodying the product data (not shown), and wherein the vendor computer 300 generally undertakes the execution of executable instructions that are associated with the display and manipulation of the virtual model (i.e. server-based implementation), whereby the data storage and processing requirements of the molding system computer 100 are minimized (i.e. thin client).

### Step 502:

Method 500 begins at step 502, with the vendor computer 300 receiving an indication from the molding system computer 100, over the communications network 102, of a requirement to display a virtual model 160 of the molding system 30. The indication includes, in a non-limiting embodiment, a signal having information regarding the molding system 30 that is requested to be displayed (e.g. the molding clamp 32, mold 36, etc.) on the display 120 of the human-machine interface 110. Alternatively, for example, the indication could simply be a request for to display a pre-defined selection of the molding system 30.

In response to the receipt of the indication to display the virtual model 160, the vendor computer 300 proceeds to execution of step 504.

### Step 504:

Method 500 continues at step 504, with the vendor computer 300 sending a virtual model display signal to the molding system computer 100, over the communications network 102, with which to display the virtual model 160 on the display 120. More particularly, the vendor computer 300, having access to the instructions of the visualization routine, performs the operations of reading the model data (not shown), generating a virtual model display signal with which to display the virtual model 160 (FIG. 1) on the display 120 (FIG. 1), and sending the virtual model display signal to the molding system computer 100 over the communication network 102.

Next, the vendor computer 300 proceeds to execution of step 506.

### Step 506:

Method 500 continues at step 506, with the vendor computer 300 receiving an indication, over the communications network 102, of the selected entity model 170 of the virtual model 160.

In response to the receipt of the indication of the selected entity model 170, the vendor computer 300 proceeds to execution of step 508.

### Step 508:

Method 500 typically ends at step 508, with sending an entity information signal to the molding system computer 100, over the communications network 102, with which to display part information 180 relating to the selected entity model 170. More particularly, the vendor computer 300, having access to the instructions of the visualization routine, performs the operations of reading the part data, generating a virtual model display signal to display the virtual model 160 (FIG. 1) along with the part information 180 that is associated with the selected entity model 170, and sending the virtual model display signal to the display 120 (FIG. 1) over the communication network 102.

The method 500 may further include the additional steps of receiving an indication from the molding system computer 100, over the communications network 102, of a requirement to manipulate the display of the virtual model 160 on the display 120, and thereafter sending a further virtual model display signal to the molding system computer 100, over the communications network 102, with which to display a manipulated form of the virtual model 160. The indication is the result of the operator 101 using the navigator tool 140 to convey instructions for manipulating the virtual model 160, for example, to reveal an entity model corresponding to a part of the molding system 30 of interest.

The method 500 may further include the additional steps of receiving an indication from the molding system computer 100, over the communications network 102, of a demand for a part of the molding system 30 that corresponds with the selected entity model 174, and causing an enterprise resource planning system associated with the vendor computer 300 to manage a fulfillment of the demand for the part of the molding system 30. The indication is the result of the operator 101 using the part information tool 190 requesting that the vendor 301 provide (e.g. replace, sell, etc.) a part of the molding system 30.

The method 500 may further include the additional steps of receiving an indication from the molding system computer 100, over the communications network 102, of a demand for an auxiliary operation to be performed on a part of the molding system 30 that corresponds with the selected entity model 174, and causing an enterprise resource planning system associated with the vendor computer 300 to manage a fulfillment of the demand for the auxiliary operation to be performed on the part of the molding system 30. The indication is the result of the operator 101 using the part information tool 190 requesting that the vendor 301 perform an auxiliary operation (e.g. maintenance) on a part of the molding system 30.

### Non-Limiting Examples of Operation:

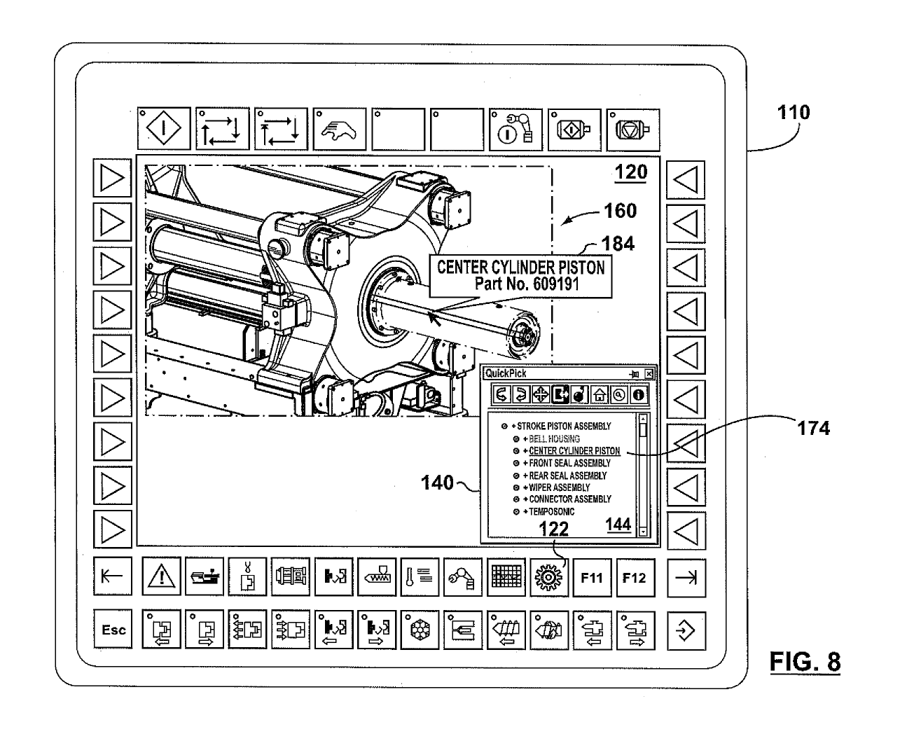

With reference to the FIGS. 1-10, there is shown a sequence of views of the human-machine interface 110 as would be seen by the operator 101 (FIG. 14 or 15) of the molding system 30 during a non-limiting example of the operation of the human-machine interface 110, in accordance with the method 400, wherein the operator 101 is searching for part information 184 (FIG. 8) in relation to a center cylinder piston of the machine clamp 32 (FIGS. 14 and 15). The center cylinder piston is a part of a clamp block assembly of the molding clamp 32 that is involved in the actuation (i.e. movement) of the moving platen.

FIG. 1 shows the human-machine interface 110 at the point of initiating the search wherein the operator 101 (FIG. 14 or 15) has already completed the step of depressing the model navigator button 122, thereby sending an indication to the molding system computer 100 of a request to display the virtual model 160 of the molding system 30 (FIGS. 14 and 15), and the molding system computer 100 having responded by displaying the virtual model 160 of the molding clamp 32 (FIGS. 14 and 15) of the molding system 30 on the display 120. Note that the entity model listing 146 in the pane 144 of the navigator tool 140 indicates that the molding clamp on display is the ‘HYMET 1000 MOLDING CLAMP’, as described previously.

In this example, the operator 101 (FIGS. 14 and 15) does not immediately see the part of interest as it is shielded from view by the gate assembly of the molding clamp, amongst other things Accordingly, the operator 101 must first hide the entity model of the gate assembly. As shown with reference to FIG. 2, the operator 101 first operates the display input device (not shown) to arrange the selection pointer 121 over the display of the gate assembly, thereby making a provisional selection thereof, and in so doing the display 120 is automatically updated to display the part information 180 that is associated therewith in a display bubble. Note, that the entity model listing 146 has also been automatically updated to reveal an upper level listing of entity models of the virtual model 160 that includes the entity model corresponding to the gate assembly.

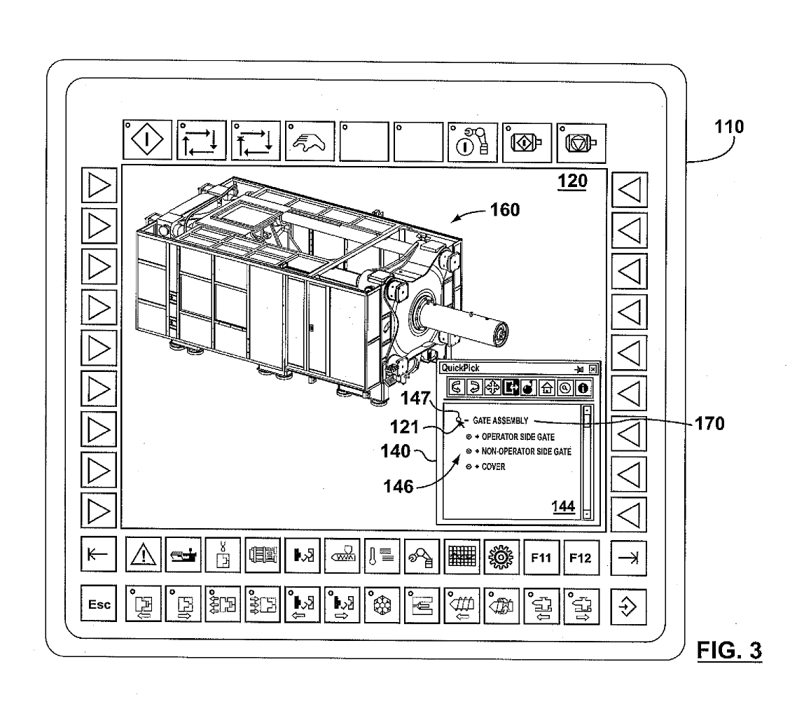

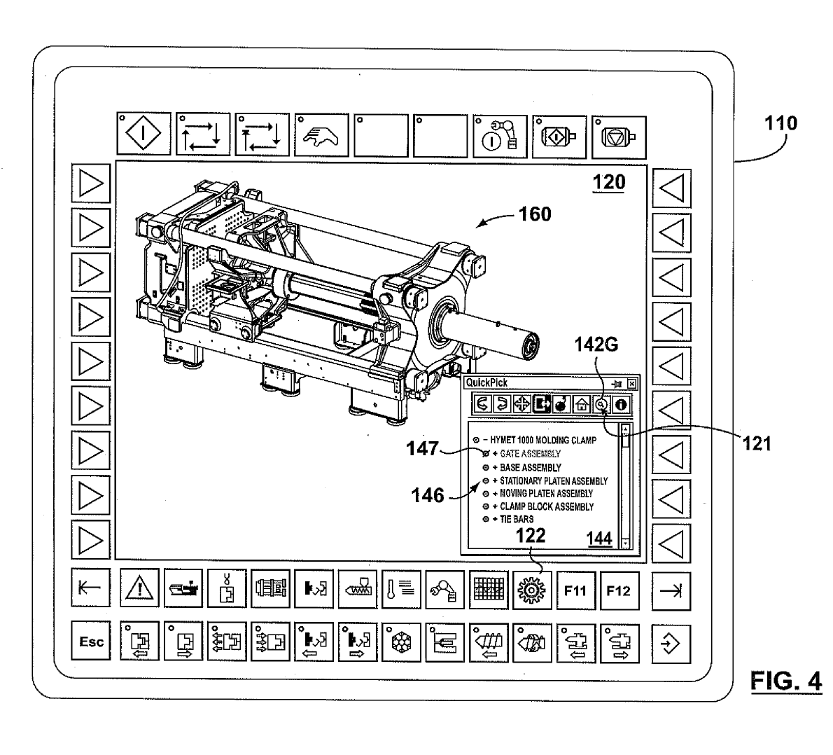

As shown with reference to FIG. 3, a further manipulation of the display input device (not shown) to select the entity model corresponding to the gate assembly has the effect of further updating the entity model listing 146 to display the entity models associated therewith (i.e. operator side gate, non-operator side gate, and a cover). Also shown in FIG. 3 is the selection pointer 121 arranged over the entity suppression icon 147, displayed next to the entity model of the gate assembly in the entity model listing 146, the selection of which has the effect of suppressing (i.e. hiding) the display of the gate assembly from the virtual model 160, as shown with reference to FIG. 4. Note that the entity model corresponding to the gate assembly remains in the entity model listing 146 but is represented in a grayed-out font and with a strike-through form of the entity suppression icon 147 so as to indicate that the entity model is not currently displayed.

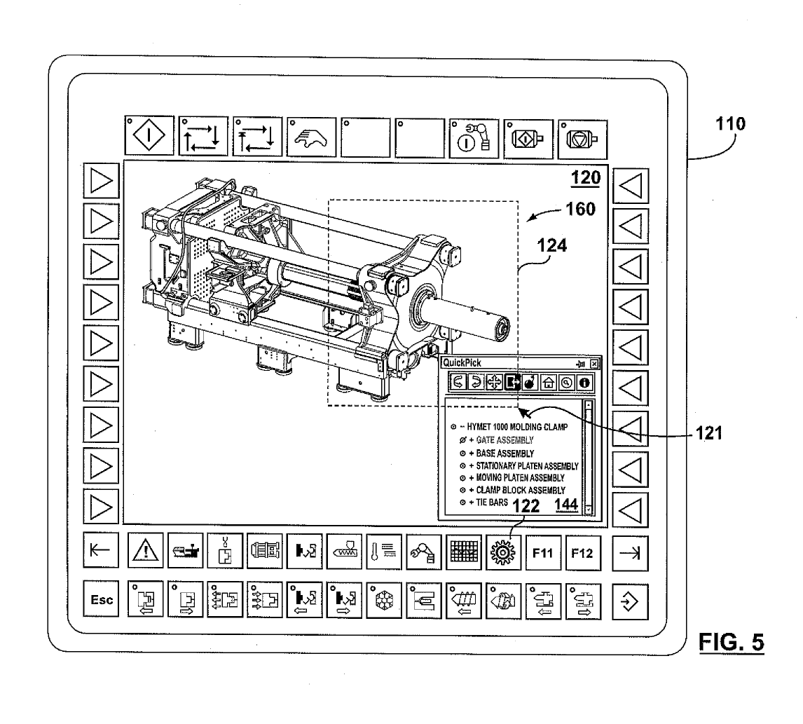

The operator 101 (FIGS. 14 and 15) would next like to focus in on the area of the molding system 30 where the center cylinder piston is believed to be located. Accordingly, and as shown with reference to FIG. 4, the operator 101 (FIGS. 14 and 15) first arranges the selection pointer 121 over the zoom icon 142G in the navigator tool, for a selection thereof, whereafter the operator 101 delineates a selection box 124 within the display of the virtual model 160, as show with reference to FIG. 5, for sake of indicating the portion that is to be enlarged within the display.

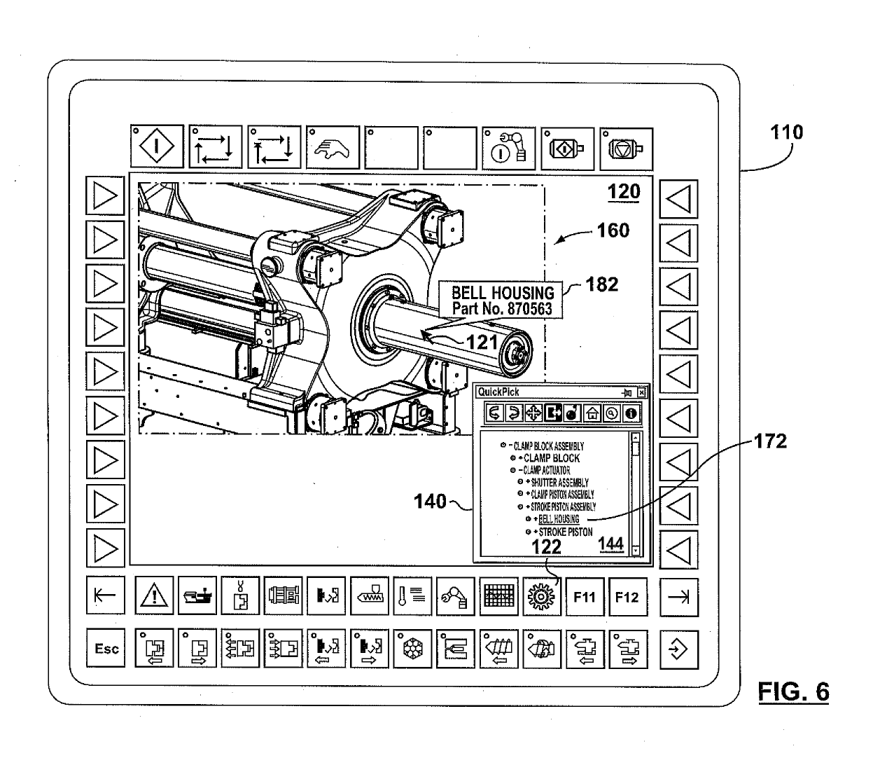

The operator 101 (FIGS. 14 and 15) still cannot see the center cylinder piston as it remains shielded from view by a bell housing of the clamp block assembly. Accordingly, the operator 101 must first hide the entity model of the bell housing. As shown with reference to FIG. 6, the operator 101 first operates the display input device (not shown) to arrange the selection pointer 121 over the display of the bell housing, thereby making a provisional selection thereof, and in so doing the display 120 is automatically updated to display the part information 182 that is associated therewith in a display bubble. Note, that the entity model listing 146 has also been automatically updated to reveal an upper level listing of entity models of the virtual model 160 that includes the selected entity model 172 corresponding to the bell housing.

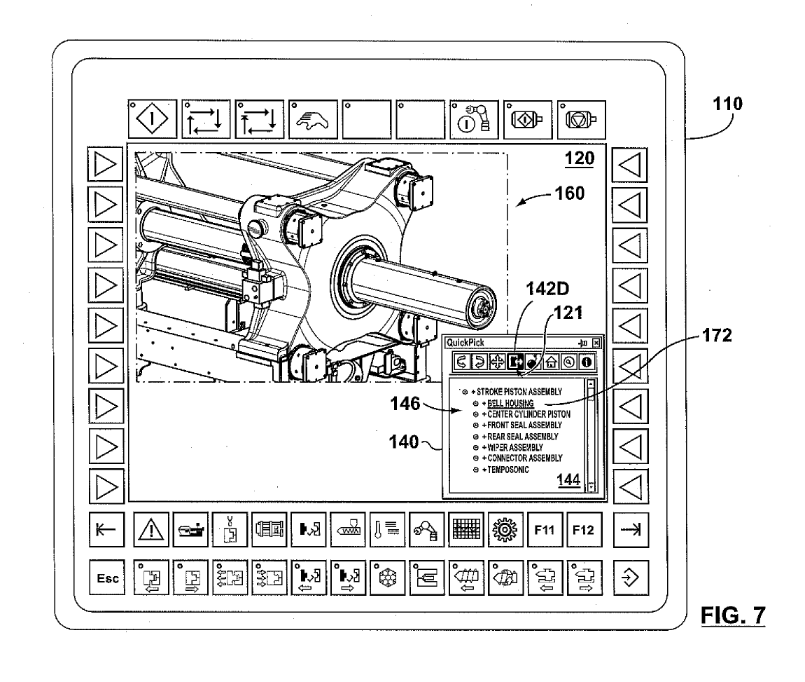

As shown with reference to FIG. 7, a further manipulation of the display input device (not shown) to select the entity model corresponding to the bell housing has the effect of further updating the entity model listing 146 to display the entity models associated therewith, which include the parts of a stroke piston assembly (i.e. bell housing, center cylinder piston, front seal assembly, rear seal assembly, wiper assembly, connector assembly, and a temposonic). Also shown in FIG. 7 is the selection pointer 121 arranged over the translucency icon 142D of the navigator tool 140, the selection of which has the effect of selectively suppressing (i.e. semi-transparent) the display of the bell housing from the virtual model 160, as shown with reference to FIG. 8, and thereby revealing the center cylinder piston. The part information 184 (FIG. 8) associated with the center cylinder piston is also shown, the part having been provisionally elected with the selection pointer 121. Note that the entity model corresponding to the bell housing remains in the entity model listing 146 but is represented in a grayed-out font.

Having located the part information 184 in relation to the center cylinder piston, the operator 101 (FIGS. 14 and 15) may next want to review any auxiliary part information associated with the part. Accordingly, and as shown with reference to FIG. 9, the operator 101 arranges the selection pointer 121 over the information icon 142H in the navigator tool 140, for a selection thereof, whereafter the part information tool 190 is displayed on the display 120, as shown with reference to FIG. 10, for displaying the auxiliary part information 192 and the virtual model 162 of the center cylinder piston, amongst other things. As discussed previously, the operator 101 could use the ordering link 194 and the quantity field 196 of the part information tool 190 to place an order for the part with the vendor 301 of the molding system 30.

With reference to the FIGS. 11-13, there is shown a sequence of views of the human-machine interface 110 as would be seen by the operator 101 (FIG. 14 or 15) of the molding system 30 during another non-limiting example of the operation of the human-machine interface 110, by the operator 101, to search for part information in relation to a stack assembly of the molding system 30.

FIG. 11 shows the human-machine interface 110 at the point of initiating the search wherein the operator 101 (FIG. 14 or 15) has already completed the step of depressing the model navigator button 122, thereby resulting in the displaying of the search tool 130 within which to enter information for searching for the virtual model 260 of the stack assembly. In this example, the information used for searching includes the part description and the job number that have been entered into the part description field 134C as ‘STACK ASSEMBLY’ and the job number field 134F as ‘103312’, respectively.

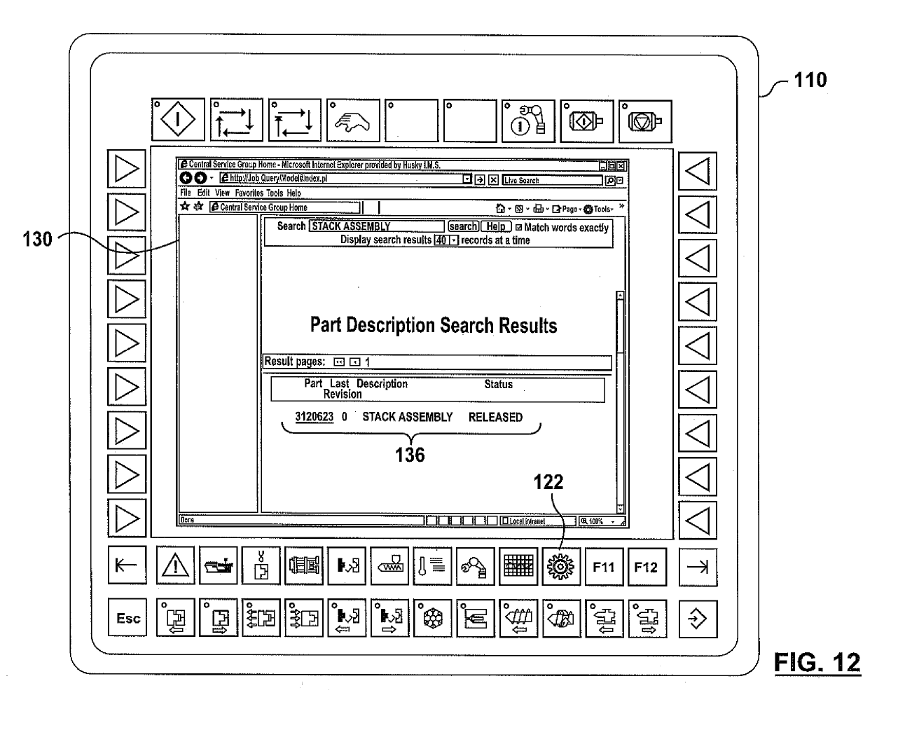

As shown with reference to FIG. 12, the search tool 130 subsequently displays a selectable link 136 to the virtual model 260 of the stack assembly. A selection of the selectable link 136, by the operator 101 (FIGS. 14 and 15), results in the display of the virtual model 260 of the stack assembly, as shown with reference to FIG. 13.

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described. Therefore, what is to be protected by way of letters patent are limited only by the scope of the following claims:

What is claimed is:

1. A human-machine interface of a molding system computer, comprising:
a display that is configured to display a virtual model of a molding system, at least in part; and
the display being further configured to display part information relating to a selected entity model of the virtual model.

2. The human-machine interface of claim 1, wherein:
the display is further configured to display a navigator tool for manipulating the display of the virtual model.

3. The human-machine interface of claim 2, wherein:
the navigator tool is configured to display a navigator toolbar that includes at least one of:
a rotation icon for selectively rotating the display of the virtual model;
a counter-rotation icon for selectively counter-rotating the display of the virtual model;
a pan icon for selectively panning the display of the virtual model;
a translucency icon for selectively adjusting a translucency of the selected entity model within the display of the virtual model;
an explosion icon for selectively manipulating a spatial representation of a plurality of entity models within the display of the virtual model;
a home icon for selectively returning the display of the virtual model to an initial view thereof;
a zoom icon for selectively magnifying a selectable portion within the display of the virtual model; and
an information icon for displaying a part information tool for selectively displaying auxiliary part information relating to the selected entity model.

4. The human-machine interface of claim 2, wherein:
the display is further configured to display an entity model listing of entity models that are associated with the selected entity model.

5. The human-machine interface of claim 4, wherein:
the display is further configured to display a pane in association with the navigator tool, for displaying the entity model listing, and wherein each entity model displayed in the entity model listing is displayed along with:
an entity suppression icon for selectively suppressing the display of the entity model; and
a list expansion icon for selectively expanding a sub-listing of associated entity models.

6. The human-machine interface of claim 1, wherein:
the display is further configured to display a search tool for searching for the virtual model.

7. The human-machine interface of claim 1, wherein:
the display is further configured to display a part information tool for displaying auxiliary part information relating to the selected entity model.

8. The human-machine interface of claim 7, wherein:
the part information tool includes a display of the virtual model of the selected entity model.

9. The human-machine interface of claim 1, wherein:
the display is further configured to display an ordering link and a quantity field for providing an indication to a vendor computer, over a communications network, of an order of a part of the molding system that corresponds with the selected entity model.

10. The human-machine interface of claim 1, wherein:
the display is further configured to display an auxiliary link for providing an indication to a vendor computer, over a communications network, of a request for an auxiliary operation to be performed in association with a part of the molding system that corresponds with the selected entity model.

11. A method executable in a molding system computer having a human-machine interface, the method comprising:
causing a display of the human-machine interface to display a virtual model of a molding system, at least in part;
receiving an indication, via the human-machine interface, of a selected entity model of the virtual model; and
causing the display to display part information relating to the selected entity model.

12. The method of claim 11, further comprising:
receiving an indication, via the human-machine interface, of a requirement to manipulate the display of the virtual model; and
causing the display of the human-machine interface to manipulate the display of the virtual model of the molding system.

13. The method of claim 11, further comprising:
receiving an indication, via the human-machine interface, of a demand for a part of the molding system that corresponds with the selected entity model; and
causing the molding system computer to send an order signal to a vendor computer, over a communications network, for requesting that a vendor associated with the vendor computer provide the part of the molding system.

14. The method of claim 11, further comprising:
receiving an indication, via the human-machine interface, of a demand for an auxiliary operation to be performed on a part of the molding system that corresponds with the selected entity model; and
causing the molding system computer to send an auxiliary signal to a vendor computer, over a communications network, for requesting a vendor associated with the vendor computer perform the auxiliary operation on the part of the molding system.

15. The method of claim 11, further comprising:
receiving an indication, via the human-machine interface, of a requirement to display auxiliary part information relating to the selected entity model; and
causing the display to display the auxiliary part information.

16. The method of claim 11, wherein:
prior to the causing the display of the human-machine interface to display the virtual model of the molding system, the method further comprising:
sending an indication to a vendor computer, over a communications network, of a requirement for a virtual model display signal from the vendor computer with which to display the virtual model on the display; and
receiving the virtual model display signal from the vendor computer, over the communications network.

17. The method of claim 16, wherein:
sending an indication to the vendor computer, over the communications network, of a requirement for a part information display signal for the selected entity model of the virtual model; and
receiving the part information display signal from the vendor computer, over the communications network, with which to display the part information relating to the selected entity model on the display.

18. A method executable in a vendor computer, the method comprising:
receiving an indication from a molding system computer, over a communications network, of a requirement to display a virtual model of a molding system;
sending a virtual model display signal to the molding system computer, over the communications network, with which to display the virtual model on a display of a human-machine interface of the molding system computer;
receiving an indication, over the communications network, of a selected entity model of the virtual model;
sending an entity information signal to the molding system computer, over the communications network, with which to display part information relating to the selected entity model.

19. The method of claim 18, further comprising:
receiving an indication from the molding system computer, over the communications network, of a requirement to manipulate the display of the virtual model on the display;
sending a further virtual model display signal to the molding system computer, over the communications network, with which to display a manipulated form of the virtual model on the display.

20. The method of claim 18, further comprising:
receiving an indication from the molding system computer, over the communications network, of a demand for a part of the molding system that corresponds with the selected entity model;
causing an enterprise resource planning system associated with the vendor computer to manage a fulfillment of the demand for the part of the molding system.

21. The method of claim 18, further comprising:
receiving an indication from the molding system computer, over the communications network, of a demand for an auxiliary operation to be performed on a part of the molding system that corresponds with the selected entity model;
causing an enterprise resource planning system associated with the vendor computer to manage a fulfillment of the demand for the auxiliary operation to be performed on the part of the molding system.

22. A molding system computer associated with a molding system, comprising:
a processor;
a human-machine interface;
an internal network for coupling the processor with the human-machine interface;
the processor having access to instructions to perform operations, including:
causing a display of the human-machine interface to display a virtual model of the molding system, at least in part; and
causing the display to display part information for a selected entity model of the virtual model.

23. The molding system computer of claim 22, further comprising:
a database coupled to the processor by the internal network;
the database embodying product data including:
model data for a plurality of entity models that are associated with the virtual model;
part data for the plurality of entity models that is associated with the virtual model.

24. The molding system computer of claim 23, wherein:
the processor having access to instructions of a visualization routine to perform operations including:
reading the product data;
causing the display of the virtual model and the part information for the selected entity model on the display from the product data.

25. The molding system computer of claim 24, wherein:
the visualization routine is further configured to include instructions that are executable by the processor with which to perform, in use, the operations of:
causing the display to display a navigator tool having a navigator icon displayed in a navigator toolbar; and
the navigator icon being associated with instructions for manipulating the display of the virtual model.
